(19) United States
(12) Patent Application Publication
(10) Pub. No.: US 2006/0230007 A1
(43) Pub. Date: Oct. 12, 2006

(54) Technique for providing care for an individual with dementia

(76) Inventors: Iris F. Boettcher, Jenison, MI (US); Betsy Kemeny, Grove City, PA (US); Rick DeShon, East Lansing, MI (US); Alan Stevens, Temple, TX (US); Kevin Boettcher, Paoli, PA (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 11/367,635

(22) Filed: Mar. 3, 2006

Related U.S. Application Data
(60) Provisional application No. 60/658,105, filed on Mar. 3, 2005.

(51) Int. Cl. G06E 3/00

(52) U.S. Cl. 706/20

(57) ABSTRACT

A method for providing care to individuals with dementia is provided. Initially, personal information about an individual with dementia, called person-centered care data, is developed. Next, the person-centered care data is distributed to caregivers, and care is provided to the individual based upon the person-centered care data. The person-centered care data may be developed through interaction with the individual and/or family members. Person-centered care data may also be developed through observation of the individual by caregivers, and may include individual biographical and preference information. Caregivers may be observed by supervisors or mentors when interacting with the individual, and provided feedback for performance improvement based upon the observations. Furthermore, goal-setting may take place between the supervisor or mentor and the caregiver to improve the ability of the caregiver to provide person-centered care. The method is therapeutic for persons with dementia by reducing agitation and improving quality of life.

### CROSS-REFERENCE TO RELATED APPLICATION

This application claims the benefit under 35 U.S.C. § 119(e) of U.S. Provisional Application No. 60/658,105, filed on Mar. 3, 2005, the entire disclosure of which is hereby incorporated herein by reference.

### BACKGROUND OF THE INVENTION

The present invention is generally directed to providing care for an individual and, more specifically, to providing care for an individual with dementia.

In general, dementia occurs when an individual loses critical thinking skills. Dementia may also include memory loss in the individual, and may occur due to changes in the brain attributable to disease or injury. Typically, the changes in the brain are irreversible and become progressively worse with time. A number of different medical problems can cause dementia. For example, dementia is commonly attributable to Alzheimer's disease, vascular degeneration and other diseases, such as Pick's Disease, Parkinson's disease and alcoholism. Further, lack of proper nutrients, depression, brain damage after infection or head injury, or combining a number of medications may cause an individual to experience dementia. Irrespective of the cause of dementia, individuals with dementia generally have trouble doing common tasks that require multiple steps, e.g., cooking, dressing, shopping and housework. A person with dementia may lose control of their emotions. Examples include failing to respond emotionally to others, withdrawing from others, or over-responding emotionally. An individual with dementia lacks the ability to start tasks, or lacks the ability to stop doing things once they begin. Further, an individual may do things on impulse, without considering the consequences of his or her actions.

Traditionally, individuals with dementia have been treated through a non-person-centered care approach. Utilizing this approach, care is typically focused on providing a safe environment for an individual and meeting the individual's needs for food, clothing, warmth, toiletry, cleanliness, etc. In general, this approach treats problem behaviors as conditions that must be managed skillfully, requiring staff to put aside their own feelings and the feelings of the individual with dementia, and get the job/task done as quickly and as efficiently as possible. While prior techniques for caring for individuals with dementia have, in general, provided adequate care for the individual, these techniques have not addressed other important areas, such as caregiver morale and turnover. Further, these approaches have typically focused on the individual's physical needs, and have not treated an individual with dementia as a person having a unique history, unique emotional needs, and unique preferences and desires.

What is needed is a technique for providing personalized care for an individual with dementia that treats the individual as a person, while reducing the agitation level of the individual and providing a more rewarding experience for an associated caregiver.

### SUMMARY OF THE INVENTION

The present invention is generally directed to a method for providing care for an individual with dementia. The method is based on a Dynamic Model of Dementia Care that comprehends the complex interaction and relationships in a formal care system among formal care providers, dementia care recipients, and the family of individuals with dementia. The Dynamic Model is described in U.S. Provisional Application No. 60/658,105, referenced above. In the method, personal information about an individual with dementia, called person-centered care data, is developed. Next, the person-centered care data is distributed to caregivers. Then, care is provided to the individual, based upon the person-centered care data. The person-centered care data may be developed through interaction with one or more family members of the individual and may include food, clothing and bathing preferences of the individual. The person-centered care data may also be developed through observation of the individual by the caregivers. In various embodiments, the person-centered care data includes biographical information of the individual. According to one embodiment, the method may include the step of developing skills of the caregivers in non-verbal initiation of conversation, communication, promoting independence, promoting lifestyle pursuits and responding to need-driven behaviors of the individual with dementia. The caregivers may include nurse assistants, nurses, housekeeping and food service. According to another embodiment of the present invention caregivers are observed when providing care to the individual, and are provided feedback for performance improvement. The feedback is based on observation of the interaction of the caregiver with the individual. The caregiver is provided with goals to improve caregiver interaction with the individual having dementia.

In accordance with one aspect of the present invention, a method for providing person-centered care for an individual with dementia is provided. The method includes the steps of gathering person-centered care data about the individuals, providing the person-centered care data to caregivers providing treatment to the individuals, and providing care to the individuals using person-centered care data and techniques.

In accordance with another aspect of the present invention, a method for providing person-centered care for an individual with dementia is provided. The method includes the steps of gathering person-centered care data about the individual, providing the person-centered care data to caregivers providing treatment to the individual, and providing care to the individual using person-centered care data and techniques. The method further includes the steps of selecting caregiver person-centered care metrics for measuring caregiver performance, monitoring caregiver performance to the metrics, and providing caregiver metric performance feedback to the caregiver. The method also includes the steps of establishing a caregiver growth plan with improvement goals, tracking the caregiver's progress to the improvement goals, and reviewing the growth plan and progress with the caregiver.

In accordance with yet another aspect of the present invention, a method for providing person-centered care for an individual with dementia is provided. The method includes the steps of training caregivers in person-centered care, gathering person-centered care data about the individual, and providing the person-centered care data to caregivers providing treatment to the individual. The method also includes the step of providing care to the individual using person-centered care data and techniques. The method further includes the steps of selecting caregiver person-centered care metrics for measuring caregiver performance, monitoring caregiver performance to the metrics, and providing caregiver metric performance feedback to the caregiver. The method also includes the steps of establishing a caregiver growth plan with improvement goals, tracking the caregiver's progress to the improvement goals, and reviewing the growth plan and progress with the caregiver.

These and other features, advantages, and objects of the present invention will be further understood and appreciated by those skilled in the art by reference to the following specification, claims, and appended drawings.

### BRIEF DESCRIPTION OF THE DRAWINGS

The present invention will now be described, by way of example, with reference to the accompanying drawings, in which:

FIG. 1 is a flow diagram illustrating a method for providing person-centered care for an individual with dementia, according to one embodiment of the present invention;

FIG. 2 is a flow diagram illustrating a method for providing person-centered care for an individual with dementia, according to another embodiment of the present invention; and

FIG. 3 is a flow diagram illustrating a method for providing person-centered care for an individual with dementia, according to yet another embodiment of the present invention.

### DETAILED DESCRIPTION OF PREFERRED EMBODIMENTS

According to the present invention, an evidenced-based, relational, person-centered system of care for individuals with dementia is provided. The system provides for the training of healthcare providers, informal caregivers and family members by focusing on the individual with dementia as a person, not as an object for which a task needs to be accomplished. Through various trials, the system has demonstrated consistent, measurable improvements in care outcomes for persons with dementia. The system is widely applicable to a variety of care sites, e.g., homes, daycare facilities, assisted living facilities and nursing homes. The system implements current best practice caregiver training in order to sustain desirable outcomes.

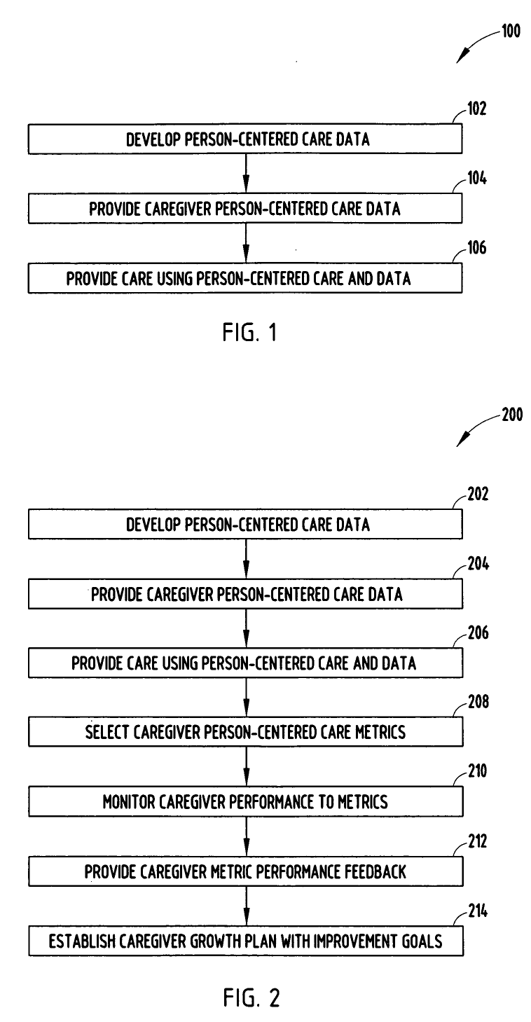

Referring to FIG. 1, a method 100 for providing person-centered care for an individual with dementia is provided, according to one embodiment of the present invention. In a first step 102 of the method, person-centered care data about an individual with dementia is developed. Person-centered care data includes personal information about the person with dementia that can be useful in assisting with treatment. Person-centered care data includes both biographical information and information about the individual's subjective opinions and personal preferences. The biographical information includes information, such as where the individual was born, where the individual lived most of his or her life, the name of the individual's spouse or significant other, and whether or not the spouse or significant other is living or deceased. The personal preference information includes: types of food the individual likes or dislikes; the color, type, and style of clothing the individual prefers; when and how the individual likes to be bathed; and the name the person likes to be called.

Additional subjective opinion or personal preference person-centered care data includes the identification of the person or persons who are most important to the individual in their earliest years, the individual's most important friend or relative at this time, the individual's favorite job now and/or in the past, and the individual's favorite thing to do. The personal preference and/or subjective opinion information also includes music likes and dislikes, what the individual's biggest accomplishment has been, the most important thing the individual does to belong, what makes the individual feel useful, what makes the individual feel loved and/or happy, how the individual is best comforted when upset, and what makes the individual feel safe and secure. In an alternate embodiment of the present invention, the person-centered care data includes additional biographical, personal preference, and/or subjective opinion information.

The person-centered care data described above is developed by direct interaction with the individual having dementia and his or her family members. The person-centered care data development process includes directly questioning the individual and his or her family members about biographical information, subjective opinion, and personal preferences. The person-centered care data is also developed through the observation of the individual with dementia by care providers. Certain elements of the person-centered care data can also be developed from reviewing the chart of the individual with dementia. As person-centered care data is gathered, it is stored in records for later retrieval and distribution. The person-centered care data described above is developed by healthcare providers, including both primary caregivers and informal caregivers, such as, for example, nurses, nurses' assistants, housekeeping providers, food service providers, mentors, and supervisors. Person-centered care data is also developed by family members.

In a second step 104 of the method, person-centered care data is provided to primary and informal caregivers, such as, for example, nurses, nurses' assistants, housekeeping providers, food service providers, mentors, and supervisors. The person-centered care data is provided in the form of a written record, such as, for example, a personal information sheet for an individual with dementia.

In a third step 106 of the method, care is provided to the individual with dementia using person-centered care techniques and the person-centered care data developed in step 102 and distributed in step 104. Person-centered care techniques differ from traditional non-person-centered care techniques in that they focus on treating individuals with dementia as persons having emotional and social needs in addition to physical needs. In delivering person-centered care, the caregiver focuses on helping the individual with dementia to feel like they belong, feel useful, feel in control of themselves, feel loved, and to feel that someone is devoted to them, and will help them feel safe. Caregivers use the person-centered care data to develop an understanding of the patient's abilities, tastes, interests, values, and spirituality, and incorporate the person-centered care data into the interaction with, and treatment of, the individual with dementia. Caregivers providing person-centered care also focus on building relationships with the individual based on person-centered care data, using person-centered care data to observe behaviors and identify unmet needs, and to promote the individual's independence and lifestyle pursuits. Caregivers providing person-centered care also avoid talking to residents in certain ways that will upset them, and strive to break down tasks for residents into manageable chunks to avoid frustration.

In delivering person-centered care, the caregivers focus on three specific areas. The first area of focus is effectively talking and communicating with individuals with dementia. The general principles employed in effectively talking and communicating with individuals with dementia include using non-verbal means to initiate the conversation, building trust with the individuals with dementia, and giving residents choices without overwhelming them. The caregivers also focus on making positive statements to residents in acknowledging the residents' feelings. To more effectively communicate, caregivers focus on using single verbal cues and matching the verbal cues to gestures. In addition, caregivers focus on pausing between verbal cues to allow the individual with dementia to process the verbal cues. To more effectively acknowledge residents' feelings, caregivers focus on matching the acknowledging statements to both the tone of voice and facial expressions and body language used. Caregivers also avoid disempowering the residents by lying, doing activities for them, treating them like children, labeling them (e.g., calling them a feeder or a wanderer), threatening them, isolating them, overwhelming them, controlling them, putting them down, punishing them, treating them like objects or things, ignoring them, withholding from them something they're asking for, accusing, interrupting, or startling them. In addition, caregivers avoid making fun of and discouraging individuals with dementia.

In employing person-centered care in the area of communications with the patient, caregivers also employ three tools called START, TALKS, and LISTEN. The START tool is used to help initiate conversations. The START tool includes standing slightly to the side and smiling (S), touching in a manner similar to a handshake (T), approaching gently and at the patient's eye level (A), relaxing by taking a deep breath and trying not to sound rushed (R), and taking enough time to let the individual respond (T).

The second person-centered care tool is called TALKS, and is used to effectively carry on a conversation with an individual with dementia after the conversation has been initiated using the START tool. The TALKS tool includes talking slowly and using gestures (T), asking questions with choices (A), learning the words a person uses for different items and using them (L), keeping things simple (K), and helping the individual to save face by not arguing with them or correcting them (S). In carrying on a conversation using the TALKS tool, caregivers avoid behaviors, such as lying to the patient to get them to do something, doing tasks for the individual when they can do them themselves, treating the individual like a child, threatening, labeling, or overwhelming the individual with too many choices, and controlling the individual. Caregivers also avoid putting down, punishing, or ignoring the individual, treating them like an object, accusing them or arguing with them, interrupting or startling them, and making fun of them.

The third tool used to communicate with an individual with dementia using a person-centered care technique is the LISTEN tool. The LISTEN tool includes listening for the individual's feelings and supporting them (L), having the caregiver clear his or her own mind of their own concerns to focus on the individual (I), stopping talking long enough to hear what the individual is saying (S), trying to understand what the individual is seeing, hearing, and feeling (T), getting the individual's eyes to focus on your eyes (E), and using non-verbal gestures to let the individual know you are listening (N).

The second specific area of focus for caregivers providing care to an individual using person-centered care techniques is employing person-centered care data in various aspects of interaction and patient treatment. The general person-centered care approach is to get to know the person using the person-centered care data. This improves the caregivers' ability to effectively converse with the resident and the resident's family, to know what the individual's capabilities are when assisting them with care, to assist in planning activities that are truly meaning to the individual having dementia, and to set up an effective daily interaction/treatment plan based on the individual's lifelong habits.

Using person-centered care data allows caregivers to meet the needs of the individual as outlined in the BUILDS acronym. The person-centered care data can be used by caregivers to help the patient feel like he or she belongs (B), to feel useful (U), to feel like an individual (I), to feel loved (L), to feel that someone is devoted to him or her (D), and to feel safe (S). Caregivers use person-centered care data to enhance treatment by incorporating person-centered care data into what is talked about with the individual, to plan the individual's day to include activities that are meaningful to the individual, and to factor the individual's habits into discussions and/or activities. Caregivers also use the person-centered care data to comfort upset residents, and to know what to talk about, and how best to talk about it, with the individual.

Person-centered care data is also used by caregivers to help the individual recollect their past accomplishments and to feel proud (referred to as recollecting), to provide meaningful things for the caregivers to discuss with the individual, and to help build the relationship. Person-centered care data is also used by caregivers to tailor the daily activities of the individuals to help meet the BUILDS needs outlined above. Finally, having access to person-centered care data helps the caregivers to plan and match activities to what the individuals would want to be doing if they were not in a nursing home or managed care setting.

The third specific technique used by caregivers in providing person-centered care is watching the individual's behavior for cues of unmet needs, and effectively responding to those needs using person-centered care data. Caregivers delivering person-centered care observe the behavior of the individual for cues indicating possible physical comfort issues, such as hunger or thirst, problems with elimination, pain, and lack of sleep. In addition to watching for cues for physical comfort issues, caregivers providing person-centered care watch for cues for non-physical needs, and the feelings and emotions associated with those needs. These cues include an individual hitting in a care situation, constantly walking around the facility or leaving the facility, making noises or repeating words, and saying “no” to care or eating.

Caregivers providing person-centered care employ two tools to effectively deal with the needs behind cues communicating unmet needs. The first tool is CALL and includes helping the individual to cope (C), avoid arguing with the individual (A), looking at the person with the correct posture and eye level (L), and leading them to feel safe and helping them retain their dignity (L).

A second tool used by caregivers providing person-centered care to respond to the needs behind cues communicating unmet needs is HELP. HELP includes hatching a plan by trying to determine what the individual is trying to tell you and discussing the plan with other team members (H), not erasing or ignoring the individual's actions (E), not labeling the action (L), and planning for the long-run to address the underlying issues (P).

By employing person-centered care data in each of the three person-centered care focus areas outlined above (initiating and sustaining interaction with the individual, planning and providing care to the individual, and recognizing and responding to the individual's behavioral cues), the care provided for the individual can be enhanced, agitation of the individual can be reduced, and job satisfaction for caregivers can be increased as they see improved results of their care delivery.

Referring to FIG. 2, a method 200 for providing person-centered care for an individual with dementia is provided, according to another embodiment of the present invention. In a first step 202, person-centered care data is developed. In a second step 204, caregivers are provided person-centered care data. In a third step 206, care is provided to an individual with dementia using person-centered care techniques and person-centered care data. It should be appreciated that steps 202-206 are identical to steps 102-106 of the previous embodiment discussed above and shown in FIG. 1. In a further step 208, the method provides for the selection of person-centered care metrics by which the performance of a caregiver is to be measured. The metrics are chosen to evaluate how effectively caregivers are providing person-centered care. More specifically, the metrics evaluate how frequently caregivers employ person-centered care behaviors and techniques in a number of metric areas. Metrics are selected by caregiver mentors and/or supervisors.

A first selected metric area considers how effectively caregivers use person-centered care techniques in starting an interaction with an individual having dementia. Specific metrics employed in this area include how often the caregiver: approaches the resident slowly; stands slightly to the resident's side; extends a hand palm-up as a greeting; makes eye contact with the resident; pauses after telling the resident what will happen next; smiles at the resident; addresses the resident by name; tells the resident his or her name; gets down to the resident's eye level; and treats the resident gently.

A second selected area evaluates how often caregivers exhibit person-centered care behaviors when helping an individual with tasks. Specific metric data points evaluated include how often the caregiver: asks the resident to do a task using a single verbal cue followed by a five-second pause; pauses between sentences; asks the resident questions with choices in which they can answer yes or no; demonstrates a task for the resident using gestures that match the single verbal cue; uses hand-over-hand-under assistance to help a resident begin a task; asks the resident to choose between two alternatives; and encourages the resident to complete the task without assistance once getting them started.

A third metric area evaluates caregiver effectiveness in utilizing person-centered care behaviors in conversation. Specific metric data points include how often a caregiver: compliments the resident on their appearance or actions; expresses what he or she thinks the resident is feeling based on his or her words or actions; responds to feelings expressed by the resident; treats the resident with respect; speaks to the resident as an adult; refers to the resident by his or her name and not behavior labels, such as the “wanderer,” the “hitcher,” etc.; uses soothing non-threatening language when speaking to residents; and does not interrupt or talk over the resident.

Metrics are also used in a fourth area to monitor caregiver effectiveness using person-centered care behaviors in initiating lifestyle activities. Specific metric data points include how often a caregiver: initiates resident involvement in an everyday activity; initiates resident involvement in an activity that has one repeating step; initiates resident involvement in an activity that has a rhythm; initiates resident involvement in activities appropriate for adults; and initiates resident involvement in an activity that matches interests or accomplishments captured as person-centered care data.

Metrics are also used in another area to evaluate how effectively caregivers are exhibiting person-centered care behaviors when answering calls for help. Specific metric data points evaluated include how often a caregiver: makes statements that reassure; helps the resident escape the situation; redirects the resident to another task or train of thought; does not argue or reason with the resident; asks the resident specific questions to resolve the situation; asks the resident fact questions to show empathy and avoid “why” questions; seeks to identify the real need behind the behavior; and responds to the resident.

Caregivers are also evaluated in how effectively they exhibit person-centered care behaviors and use person-centered care data in treating residents as unique individuals. Specific metric data points include how often a caregiver: uses the resident's preferred name; refers to the resident's biggest accomplishments; refers to the resident's most important person; refers to the resident's favorite activity; refers to the resident's favorite food; and refers to other topics and information captured as person-centered care data.

Finally, caregivers are evaluated on how effectively they exhibit person-centered care behaviors when relating to the individual's family. Specific metric data points include how often a caregiver: restates what he or she thinks the family members are feeling; responds to the feelings expressed by the family members; asks the family members' opinions about the resident's care; acknowledges and greets the family members by name; invites the family members to attend an activity with the resident; and responds constructively to family members' concerns or complaints about the resident's care.

Using the person-centered care metrics identified in step 208, additional steps 210-214, referred to as person-centered mentoring, are employed to enhance the quality of patient care and the job satisfaction of caregivers. Person-centered mentoring involves caregivers and their mentors and/or supervisors, and differs from a traditional supervisor-employee relationship in a number of ways. Person-centered mentoring stresses a relationship between supervisors and caregivers in which the supervisors seek input from caregivers with respect to performance goals. Person-centered mentoring focuses on stressing to caregivers that the person receiving care is the focus of treatment, rather than simply task completion and efficiency.

Once person-centered care metrics have been identified in step 208 of the method, caregiver performance to the metrics is monitored or observed in step 210 of the method. Caregiver performance is monitored by other caregivers on a periodic basis, such as daily. Caregiver performance is monitored by supervisors, mentors, or other caregivers when the caregiver is providing care to individuals. The person monitoring the caregiver tracks the caregiver's performance to the metrics outlined above in a record for later retrieval. The person monitoring the caregiver monitors the caregiver in a manner that shows concern for the caregiver. The monitoring focuses on the caregiver's behavior, rather than on personal characteristics of the caregiver. When monitoring caregivers for performance in multiple categories, care is taken not to allow good or bad performance in one category to effect the monitor's evaluation of the caregivers' performance in other independent categories. During the monitoring process, monitors base a caregiver's performance rating on how well the caregiver's performance matches the desired performance described in the metrics identified in step 208.

In a next step 212 of the method, caregivers are provided feedback based on their performance to the caregiver metrics. Feedback is provided on a periodic basis by a caregiver's mentor or supervisor. Both positive feedback and negative feedback are provided. Mentors and/or supervisors deliver feedback in a constructive manner, and attempt to balance the positive and negative feedback. Positive feedback stresses the positive aspects of the caregiver's performance, while negative feedback points out shortcomings in the caregiver's performance. The feedback is provided with reference to specific observed caregiver behaviors and activities. When providing feedback, care is taken to use appropriate body language, and to avoid playing favorites among caregivers.

In addition to providing specific data on the various metrics outlined above, the caregiver is provided feedback on what is expected in the future, and how to improve his or her performance to the selected metrics. During the feedback sessions, caregivers are also provided an opportunity to provide input as to items they would like to improve in their work. In addition to providing feedback at regularly scheduled periodic sessions, mentors and/or supervisors occasionally provide feedback immediately when observing the caregiver providing care. Caregivers are also encouraged to actively seek feedback from peers, supervisors and mentors on their own.

In step 214 of the method, a caregiver growth plan with improvement goals is established. A growth plan is a plan to help a caregiver improve his or her capabilities in delivering person-centered care over time. The growth plan includes goals identified by the caregiver and his or her mentor and/or supervisor. The caregiver and mentor and/or supervisor meet periodically to review progress on the growth plan. These meetings include a review of the goals, and brainstorming on actions that can be taken to help the caregiver achieve the goals in the growth plan. The goals in the growth plan are specific, challenging, achievable, realistic, and personalized. An effort is made to identify the resources needed to achieve the goals, and to provide the caregiver with the resources needed to achieve the desired goals. The targeted frequency for the meeting to review the growth plan is monthly, and the goal is to accomplish all of the actions listed in the growth plan from month-to-month. Follow-up sessions are scheduled periodically to check on the caregiver's progress, readjust the goals, and possibly make new goals.

In one exemplary growth plan, a primary growth goal (improving treating residents as unique individuals) is selected as a monthly goal from a group of possible goals. The group of possible goals includes improving person-centered care in the areas of starting the interaction, helping with independence-oriented tasks, conversation, initiating lifestyle activities, answering calls for help, treating residents as unique individuals, and relating to family. It should be appreciated that improvement goals other than these could be included in a growth plan. The growth plan includes specific actions to be taken by the caregiver to achieve the goal, including making sure the resident looks nice every day, skipping breaks to spend more time with residents, and watching how other caregivers provide care. It should be appreciated that based on the goal to be achieved, other specific actions to be taken by the caregiver to achieve the goal can be included in the growth plan. The growth plan may also include specific actions to be taken by the mentor to help achieve the goal. Finally, the growth plan includes a date at which the caregiver and mentor will review the goal to determine if it has been achieved. The caregiver and supervisor and/or mentor monitor progress during that month on the selected goal. If at the end of the month, the goal has been accomplished, the growth plan is revised, and a new goal is selected for the next month. In this way, over time, the caregiver is able to achieve progress in a number of areas.

By establishing metrics for caregivers to evaluate their performance in delivering person-centered care, providing feedback on performance to the metrics, and establishing a growth plan with mutually agreed goals, the ability of caregivers to deliver effective person-centered care can be enhanced over time.

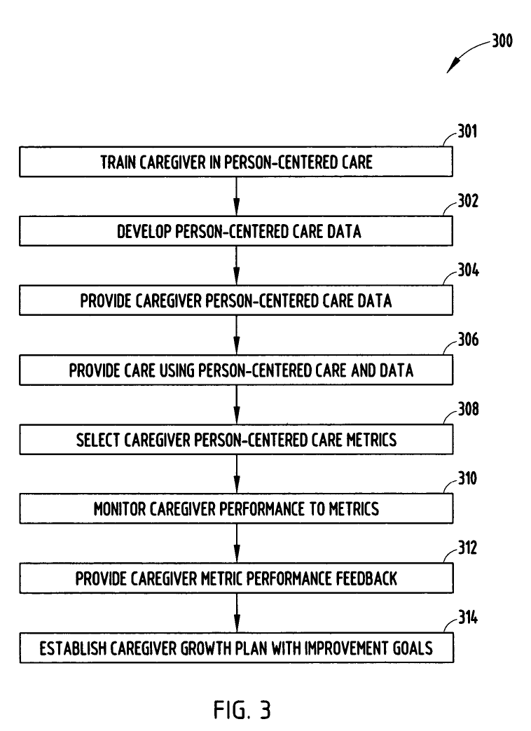

Referring to FIG. 3, a method 300 for providing person-centered care for an individual with dementia is provided, according to yet another embodiment of the present invention. The method includes steps 302-314, which are identical to steps 202-214 of the previous embodiment discussed above and described in FIG. 2. The method also includes an additional step 301 in which caregivers are trained in person-centered care. According to the method 300, caregivers are trained in person-centered care before delivering person-centered care. The caregivers to be trained include both primary and informal caregivers, such as, for example, nurses, nurses' assistants, housekeeping providers, food service providers, mentors, and supervisors. Family members may also be provided person-centered care training if they are to be involved in providing care to the individual with dementia. A first phase of the person-centered care training provides information about dementia. This includes what dementia is, how it affects people's ability to think, causes of dementia, symptoms of dementia, prognosis of individuals with dementia, and special needs of people with dementia. The first phase of training also covers the emotional effects of dementia (such as loss of control of emotions and acting on impulse), things people with dementia have difficulty doing (e.g., complex tasks requiring many steps), and other effects often associated with individuals having dementia. This phase of the training also informs trainees that individuals with dementia often retain the ability to see, hear, feel, taste, smell, feel emotions in themselves and others, and help with their own care.

The next phase of the training covers the differences between traditional non-person-centered care treatment methods and person-centered care treatment, focusing on the fact that person-centered care goes beyond just efficiently meeting the physical needs of a patient. Yet another phase of the training provides details about person-centered care, including the benefits to both caregivers and patients, what person-centered care is, and the general implications in terms of patient treatment.

Finally, another phase of the training provides specifics as to how person-centered care is delivered, and how to interact with families and staff. Specific topics covered in this phase include: what person-centered care data is and how to gather person-centered care data; non-verbal initiation of communication; how to talk and communicate effectively with individuals having dementia; how to employ person-centered care data in conversations and treatment; how to monitor and interpret verbal and behavioral cues to identify unmet needs and use person-centered care data to respond to those needs; how to effectively work with colleagues and families in a person-centered care environment; how to mentor and mentoring techniques; how to measure person-centered care performance and provide effective feedback; how to promote independence and lifestyle pursuits; and how to develop caregiver growth plans and performance goals to improve person-centered care performance.

The training in the above-described topics includes training in specific tools to help in care delivery, and in how to employ person-centered care data to enhance care delivery. In one embodiment, role playing activities (in which individuals play assigned roles as caregivers and individuals with dementia) are used to deliver the training and help caregivers better understand individuals with dementia and the person-centered care delivery process.

By providing care using person-centered care methods and data, by providing person-centered care training to caregivers, and by providing feedback and goals to caregivers to develop caregivers' ability to deliver person-centered care, the treatment of individuals with dementia, and the satisfaction of individuals providing that treatment, can be improved.

The above description is considered that of the preferred embodiments only. Modifications of the invention will occur to those skilled in the art and to those who make or use the invention. Therefore, it is understood that the embodiments shown in the drawings and described above are merely for illustrative purposes and not intended to limit the scope of the invention, which is defined by the following claims as interpreted according to the principles of patent law, including the doctrine of equivalents.

1. A method for providing person-centered care for an individual with dementia, comprising the steps of:
developing person-centered care data about an individual with dementia;
distributing the person-centered care data to caregivers; and
providing care to the individual based upon the person-centered care data.

2. The method of claim 1, wherein the person-centered care data is developed through at least one of interaction with the individual, interaction with family member of the individual, and observation of the individual by caregivers.

3. The method of claim 1, wherein the caregivers include at least one of nurse assistants, nurses, housekeeping and food service.

4. The method of claim 1, further including the steps of reviewing the individual's person-centered care data, monitoring at least one of the individual's speech and behavior for cues indicating unmet needs, and providing tailored response to those needs based on the person-centered care data.

5. The method of claim 1, wherein the person-centered care data includes biographical information of the individual.

6. The method of claim 1, further including the step of storing the person-centered care data in records, wherein the person-centered care data is distributed to caregivers by means of the records.

7. The method of claim 1, further including the step of employing person-centered care tools utilizing person-centered data to provide care to the individual, wherein the person-centered care tools include at least one of lifestyle programs and recollecting.

8. The method of claim 1, wherein the person-centered care data includes at least one element that is one of a subjective opinion and personal preference of the individual.

9. The method of claim 8, wherein the person-centered care data includes information about what makes the individual feel at least one of loved, useful, happy, important, upset and secure.

10. The method of claim 8, wherein the person-centered care data includes the food, clothing and bathing preferences of the individual.

11. The method of claim 1, further incorporating person-centered mentoring including the steps of:
identifying at least one metric by which to measure the effectiveness of person-centered care delivered by caregivers;
monitoring caregivers at least periodically when the caregivers are delivering care to the individual to determine caregiver performance relative to the at least one metric;
providing feedback regarding caregiver performance in delivering care relative to the at least one metric to the caregivers; and
providing goals to the caregivers to improve person-centered care delivery to individuals with dementia.

12. The method of claim 1, further comprising the step of providing person-centered care training to caregivers to enable the caregivers to adequately deliver person-centered care.

13. The method of claim 12, wherein the training includes training in how to interact with patient family members and staff.

14. The method of claim 12, wherein the training includes role playing activities for caregivers to help caregivers better understand individuals with dementia and the person-centered care delivery process.

15. The method of claim 12, wherein the training develops caregiver skills in non-verbal initiation of conversation, communication, promoting independence, promoting lifestyle pursuits, and responding to need-driven behaviors of individuals with dementia.

16. The method of claim 12, wherein the training includes training in the person-centered care method, dementia, and patient treatment skills.

17. The method of claim 16, wherein the dementia training includes training in at least one of what dementia is, identifying and meeting the needs of people with dementia, and how to relate to people with dementia.

18. The method of claim 16, wherein the patient treatment skills training includes training in gathering person-centered care data, determining patient needs based on verbal and non-verbal cues, and using person-centered care data in combination with at least one of interacting, lifestyle activities, and recollecting to meet patient needs.

19. The method of claim 16, wherein the training further includes training in mentoring and supervising skills for caregivers.

20. The method of claim 19, wherein the training in mentoring and supervising skills includes training in at least one of observing caregivers delivering treatment, providing feedback to caregivers based on observed treatment, and setting caregiver improvement goals.

21. A method for providing person-centered care for an individual with dementia comprising the steps of:
providing person-centered care training to caregivers to develop caregiver skills in non-verbal initiation of conversation, communication, promoting independence, promoting lifestyle pursuits, and responding to need-driven behaviors of individuals with dementia;
developing person-centered care data about an individual with dementia that includes at least one of a subjective opinion and personal preference of the individual;
storing the person-centered care data in records;
distributing the person-centered care data to caregivers;
providing care to the individual based upon the person-centered care data;
identifying at least one metric by which to measure the effectiveness of person-centered care delivery by caregivers;
monitoring caregivers at least periodically when the caregivers are delivering care to the individual, to determine caregiver performance relative to the at least one metric;
providing feedback regarding caregiver performance in delivering care relative to the at least one metric to the caregivers; and
providing goals to the caregivers to improve person-centered care delivery to individuals with dementia.
